(19) United States
(12) Patent Application Publication
(10) Pub. No.: US 2013/0254611 A1
(43) Pub. Date: Sep. 26, 2013

(54) RECOVERING DATA IN MULTIMEDIA FILE SEGMENTS

(71) Applicant: QUALCOMM INCORPORATED, San Diego, CA (US)

(72) Inventors: Daniel Amerga, San Diego, CA (US); Joseph P. Barone, San Diego, CA (US); Kuo-Chun Lee, San Diego, CA (US); Charles N. Lo, San Diego, CA (US); Shailesh Maheshwari, San Diego, CA (US); Thadi M. Nagaraj, San Diego, CA (US); Rajesh Narayanan, San Diego, CA (US); Jack S. Shauh, San Diego, CA (US); Michael G. Luby, San Diego, CA (US); Gordon K. Walker, San Diego, CA (US)

(73) Assignee: QUALCOMM Incorporated, San Diego, CA (US)

(21) Appl. No.: 13/681,144

(22) Filed: Nov. 19, 2012

Related U.S. Application Data
(60) Provisional application No. 61/615,153, filed on Mar. 23, 2012.

(51) Int. Cl. G06F 11/14

(52) U.S. Cl. CPC G06F 11/1412
USPC 714/746

(57) ABSTRACT

This application relates to systems and methods for recovering data in multimedia file segments. A communication device may receive a multimedia file segment that includes damaged data. The communication device may replace the damaged data with dummy data to reconstruct the multimedia file segment. The communication device may then play the reconstructed multimedia file segment. Thus, by replacing the damaged data with dummy data, the communication device may play a multimedia file segment even when part of the segment may be damaged.

### CROSS-REFERENCE TO RELATED APPLICATIONS

This application relates to, claims priority from, and incorporates by reference U.S. Provisional Application Ser. No. 61/615,153, filed Mar. 23, 2012, titled “DATA RECOVERY IN AUDIO OR VIDEO FILE SEGMENTS.”

### TECHNICAL FIELD

The present disclosure relates generally to electronic communications. More specifically, it relates to data recovery in multimedia file segments.

### BACKGROUND

Modern electronic devices may communicate and access information from almost anywhere at almost any time. This has allowed individuals to consume multimedia content at home, at work, or on the go, on entertainment systems, computers, tablets, smartphones, and other devices. As the demand for electronic consumption of multimedia content increases, systems and methods that improve the user experience may be beneficial.

### BRIEF DESCRIPTION OF THE DRAWINGS

FIG. 1 is a block diagram that illustrates one configuration of a communication system in which data may be recovered from multimedia file segments that comprise damaged data;

FIG. 2 is a block diagram illustrating one example of a communication device in which data may be recovered from multimedia file segments that comprise damaged data;

FIG. 3 is a block diagram illustrating some exemplary multimedia file segments;

FIG. 4 is a block diagram illustrating some additional exemplary multimedia file segments;

FIG. 5 is a flow diagram illustrating one method for recovering data in multimedia file segments;

FIG. 6 is a flow diagram illustrating another method for recovering data in multimedia file segments;

FIG. 7 is a flow diagram illustrating yet another method for recovering data in a multimedia file segment;

FIG. 8 is a block diagram illustrating a wireless communication system that may be used in one configuration of the present invention;

FIG. 9 is a block diagram illustrating an exemplary protocol layer stack that may be used in one configuration of the present invention;

FIG. 10 is a block diagram illustrating an exemplary file delivery over unidirectional transport (FLUTE) over user datagram protocol (UDP) packet;

FIG. 11 is a block diagram illustrating an exemplary dynamic adaptive streaming over hypertext transfer protocol (DASH) multimedia file segment;

FIG. 12 is a block diagram illustrating another exemplary DASH multimedia file segment;

FIG. 13 is a block diagram illustrating an interface between a file transport module and a content processing module on a communication device in one configuration that uses the DASH and FLUTE protocols;

FIG. 14 is a block diagram illustrating a DASH multimedia file segment comprising one or more damaged FLUTE packets or forward error correction (FEC) source symbols; and

FIG. 15 is a block diagram illustrating part of a hardware implementation of an apparatus.

### DETAILED DESCRIPTION

This application relates to systems and methods for recovering data in multimedia file segments. A communication device may receive a multimedia file segment that includes damaged data. The communication device may replace the damaged data with dummy data to reconstruct the multimedia file segment. The communication device may then play the reconstructed multimedia file segment. Thus, by replacing the damaged data with dummy data, the communication device may play a multimedia file segment even when part of the segment may be damaged.

In some configurations, the following description may use, for reasons of conciseness and clarity, terminology associated with Long Term Evolution (LTE) standards, as promulgated under the 3rd Generation Partnership Project (3GPP) by the International Telecommunication Union (ITU). Nevertheless, the invention is also applicable to other technologies, such as technologies and the associated standards related to Code Division Multiple Access (CDMA), Time Division Multiple Access (TDMA), Frequency Division Multiple Access (FDMA), Orthogonal Frequency Division Multiple Access (OFDMA), and so forth. Terminologies associated with different technologies can vary. For example, depending on the technology considered, a wireless device can sometimes be called a user equipment (UE), a mobile station, a mobile terminal, a subscriber unit, an access terminal, etc., to name just a few. Likewise, a base station can sometimes be called an access point, a Node B, an evolved Node B (eNB), and so forth. Different terminologies apply to different technologies when applicable.

Various configurations are described with reference to the figures. In the figures, like reference numbers may indicate functionally similar elements. The systems and methods as generally described and illustrated in the figures could be arranged and designed in a variety of different configurations. Thus, the following description of some configurations is not intended to limit the scope of the claims; rather, it is representative of some of the systems and methods encompassed by the invention.

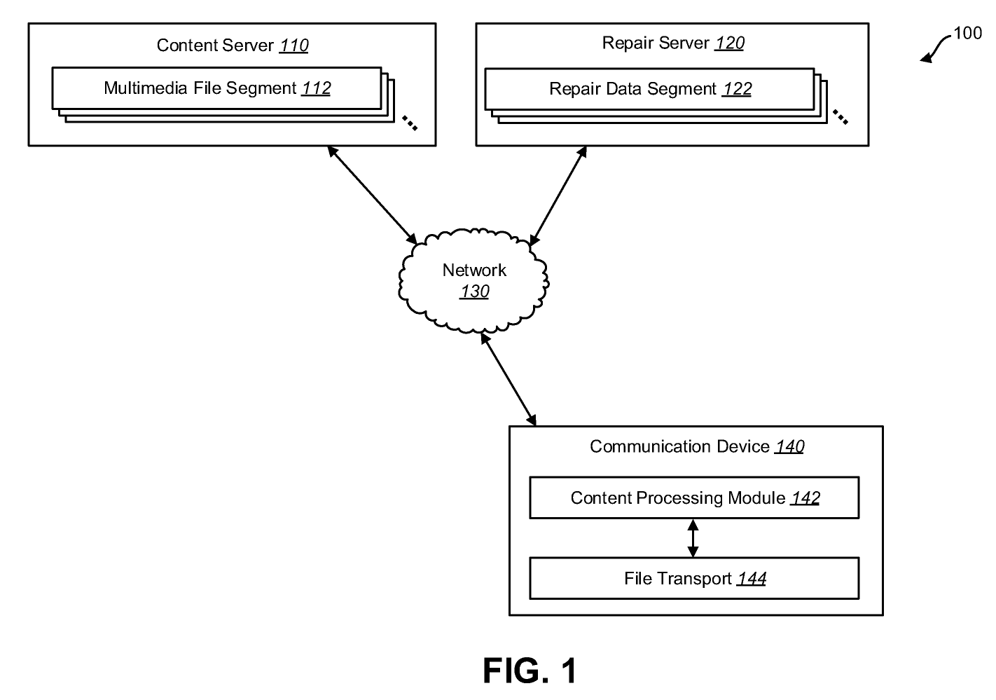

FIG. 1 is a block diagram that illustrates one configuration of a communication system 100 in which data may be recovered from multimedia file segments 112 that comprise damaged data. FIG. 1 illustrates a content server 110, a repair server 120, and a communication device 140. The content server 110, the repair server 120, and the communication device 140 may communicate over a network 130.

The content server 110 may comprise one or more multimedia file segments 112. Multimedia may refer to content comprising one or more types of media, such as audio, video, text, image, animation, interactive, etc. A file segment may be a portion of a file. A multimedia file segment 112 may be a portion of a file that includes one or more of audio, video, text, image, animation, interactive, or other types of media content.

The content server 110 may transmit and the communication device 140 may receive one or more multimedia file segments 112 over the network 130. Due to unintended errors in the communication process, the communication device 140 may receive one or more multimedia file segments 112 that comprise damaged data. Damaged data may refer to data that includes errors (e.g., corrupt data) or data that is missing (e.g., data that was not received). Data may be damaged during reading, writing, storage, transmission, processing, etc.

The communication device 140 may comprise a content processing module 142 and a file transport module 144. The content processing module 142 may be used to play multimedia file segments 112 and to compensate for damaged data. The file transport module 144 may be used to transport data and to request repair data segments 122. A module may be implemented in hardware, software, or a combination of both. For example, the content processing module 142 and the file transport module 144 may be implemented with hardware components such as circuitry or software components such as instructions or code, etc.

The repair server 120 may comprise one or more repair data segments 122. A repair data segment 122 may comprise all or part of a multimedia file segment 112. The repair data segment 122 may correspond to a damaged part of the multimedia file segment 112 and may be used to replace damaged data in the multimedia file segment 112. The repair data segment 122 may be of a higher or lower quality than the original multimedia file segment 112. For example, the original multimedia file segment 112 may comprise a video encoded at 1 Megabit per second (Mbit/s). The repair data segment 122 may comprise the same video encoded at a higher quality, e.g., at 2 Mbit/s, or at a lower quality, e.g., 0.5 Mbit/s. In another example, the original multimedia file segment 112 may comprise audio encoded at 128 kilobits per second (kbit/s). The repair data segment 122 may comprise the same audio encoded at a higher quality, e.g., at 320 kbit/s, or at a lower quality, e.g., 32 kbit/s.

Although FIG. 1 illustrates the content server 110 and the repair server 120 as distinct entities, the invention is not limited to this configuration. For example, a single device may implement the functions of both the content server 110 and the repair server 120. As another example, the system 100 may comprise multiple content servers 110 and multiple repair servers 120. Those of skill in the art will understand that any suitable configuration, now known or later developed, that provides the functionality of the content server 110 and the repair server 120 may be utilized.

The communication device 140 may request from and later receive from the repair server 120 over the network 130 one or more repair data segments 122. The communication device 140 may use the repair data segments 122 to repair or replace damaged data in received multimedia file segments 112.

The network 130 may be a wired or wireless network or a combination of both. The network 130 may comprise one or more devices that are connected to enable communications between and among the devices.

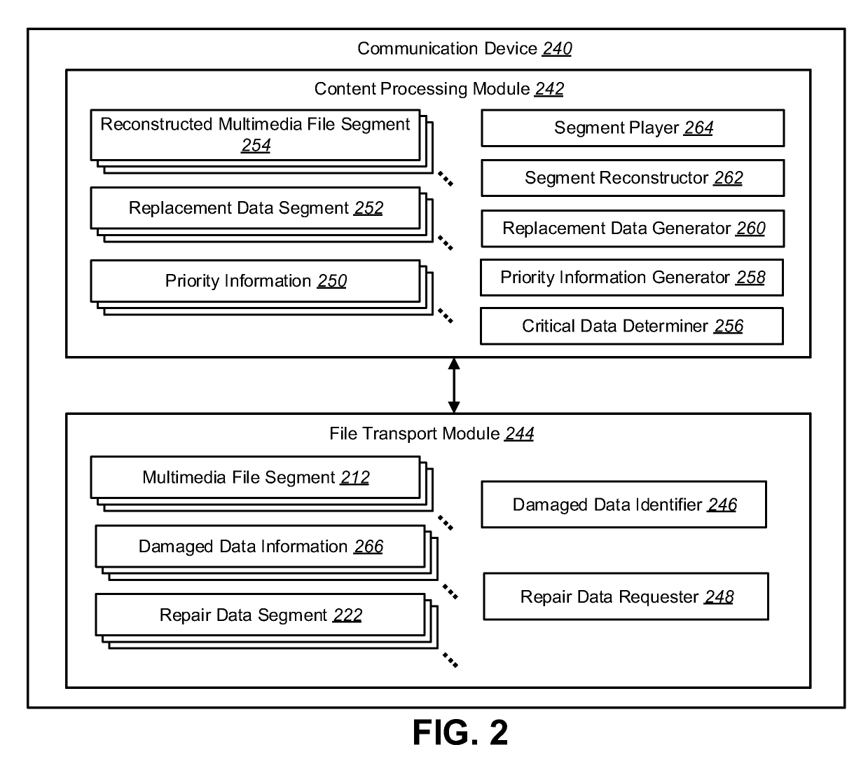

FIG. 2 is a block diagram illustrating one example of a communication device in which data may be recovered from multimedia file segments that comprise damaged data. The communication device may comprise a file transport module and a content processing module.

The communication device 240 may send and receive information to and from other devices, for example, via a network 130. The communication device 240 may use one or more wired or wireless technologies. For example, the communication device 240 may communicate over a wired network using Ethernet standards such as the Institute for Electrical and Electronics Engineers (IEEE) 802.3 standard. As another example, the communication device 240 may communicate over a wireless network using standards such IEEE 802.11, IEEE 802.16 (WiMAX), LTE, or other wireless standards. Those of skill in the art will understand that any suitable wired or wireless standard or protocol, now known or later developed, may be used. The file transport module 244 in the communication device 240 may receive and process one or more multimedia file segments 212 and one or more repair data segments 222.

The file transport module 244 may comprise a damaged data identifier 246. The damaged data identifier 246 may identify parts of the multimedia file segment 212 that comprise damaged data. In one configuration, the damaged data identifier 246 may examine the multimedia file segments 212 after error-correction processing is performed. For example, the communication device 240 may perform forward error correction (FEC) or any other suitable error correction technique on the multimedia file segment 212 before the damaged data identifier 246 processes the multimedia file segment 212. The damaged data identifier 246 may determine that part of the multimedia file segment 212 comprises damaged data in a variety of ways. For example, the multimedia file segment 212 may be transported in one or more sequentially identified data packets. The damaged data identifier 246 may determine that one or more of the sequentially identified data packets are missing. In another example, the multimedia file segment 212 may include a parity bit, a checksum, a cyclic redundancy check, a hash value, or error-correcting codes that allow the damaged data identifier 246 to determine that the multimedia file segment 212 includes damaged data. Those of skill in the art will understand that any suitable method for identifying damaged data, now known or later developed, may be used. The damaged data identifier 246 may generate damaged data information 266 that indicates the presence, the size or length, and the location of damaged data in multimedia file segments 212. The damaged data information 266 may also indicate which portions of the multimedia file segment 212 are damaged. The file transport module 244 may provide the one or more multimedia file segments 212 and their corresponding damaged data information 266 to the content processing module 242.

The content processing module 242 may comprise a critical data determiner 256 that determines whether critical parts of the multimedia file segment 212 were correctly received. A part of the multimedia file segment 212 is critical (i.e., a critical part) if the communication device 240 is unable to correctly play one or more non-damaged parts of the multimedia file segment 212 or other multimedia file segments 212 when the part is damaged. As such, whether data is critical may depend on how the media content is encoded in the multimedia file segments 212. Further, not all multimedia file segments 212 may include critical data. For example, a first multimedia file segment 212 may include critical data for one or more other multimedia file segments 212.

The critical data determiner 256 may check for the presence of critical parts in the non-damaged parts of the multimedia file segment 212. The critical data determiner 256 may also use the damaged data information 266 to determine whether the damaged parts of the multimedia file segment 212 include critical parts of the multimedia file segment 212. For example, if critical data is stored in the first 20 kilobytes of the multimedia file segment 212 and the damaged data information 266 indicates that the first 40 kilobytes comprise damaged data, then the critical data determiner 256 may determine that critical parts of the multimedia file segment 212 were not correctly received. In another example, if critical data is stored in the last 30 kilobytes of the multimedia file segment 212 and the damaged data information 266 indicates that the first 20 kilobytes comprise damaged data, then the critical data determiner 256 may determine that critical parts of the multimedia file segment 212 were correctly received. The critical data determiner 256 may also determine whether critical data for the multimedia file segment 212 was received in one or more other multimedia file segments 212 that were previously or subsequently received.

The content processing module 242 may comprise a priority information generator 258. The priority information generator 258 may generate priority information 250 based on the damaged data and the presence or absence of critical data as determined by the critical data determiner 256. Priority information 250 may indicate the importance of the damaged data. For example, the priority information generator 258 may assign a higher priority to critical data than to non-critical data. In another example, the priority information generator 258 may assign a higher priority to parts of the multimedia file segment 212 that are played earlier in time. The content processing module 242 may provide the priority information 250 to the file transport module 244.

The file transport module 244 may comprise a repair data requester 248. The repair data requester 248 may request repair data segments 222. The repair data requester 248 may prioritize the requests based on the priority information 250. Also, based on the priority information 250, the repair data requester 248 may request repair data segments 222 at a higher or lower quality. For example, the repair data requester 248 may request a repair data segment 222 of a lower quality when the priority information 250 indicates a high priority. By requesting a lower quality repair data segment 222, latency may be reduced. In other words, the communication device 240 may receive the repair data segment 222 faster. This may allow the communication device 240 to more quickly reconstruct the multimedia file segment 212 using the repair data segment 222. This, in turn, may enable the communication device 240 to avoid interrupting playback of the multimedia file segments 212 even though the quality of the playback may be reduced.

The communication device 240 may transmit the requests to a repair server 120 over a network 130. The repair server 120 may receive the request and send one or more requested repair data segments 222 over the network 130 to the communication device 240.

The content processing module 242 may attempt to compensate for damaged data in multimedia file segments 212. The content processing module 242 may comprise a replacement data generator 260 that generates one or more replacement data segments 252 based on the one or more multimedia file segments 212 and their corresponding damaged data information 266. The content processing module may further comprise a segment reconstructor 262 that may generate reconstructed multimedia file segments 254 using one or more multimedia file segments 212 and one or more replacement data segments 252. For example, the segment reconstructor 262 may replace the damaged data in the multimedia file segment 212 with one or more replacement data segments 252 to generate a reconstructed multimedia file segment 254.

In one configuration, the replacement data generator 260 may generate replacement data segments 252 that comprise dummy data. Dummy data may refer to data that does not contain useful information, but reserves space. The replacement data generator 260 may generate dummy data in a variety of ways. For example, the replacement data generator 260 may generate null or zero-fill. In another example, the replacement data generator 260 may generate random data. Those of skill in the art will understand that any suitable method for generating dummy data, now known or later developed, may be used. The replacement data generator 260 may ensure that the dummy data does not create an illegal pattern.

In another configuration, the replacement data generator 260 may generate replacement data segments 252 that comprise interpolated data. Interpolated data may be an estimate of the correct values for the damaged data that may be based on the non-damaged data. For example, media content in the multimedia file segment 212 may be correlated in time. As such, the non-damaged data preceding the damaged data and the non-damaged data following the damaged data may be used to generate interpolated data. In one configuration, generating the interpolated data may comprise decompressing the media content in the multimedia file segment 212 without the media content in the damaged data or using dummy data.

In still another configuration, the replacement data generator 260 may generate replacement data segments 252 from repair data segments 222. The repair data segments 222 may comprise the original data included in the multimedia file segment 212. The repair data segments 222 may also comprise error correction code that may be used to regenerate the original data. The repair data segments 222 may also comprise higher or lower quality versions of the original data.

The content processing module 242 may comprise a segment player 264. The segment player 264 may play the reconstructed multimedia file segments 254. Playing the reconstructed multimedia file segment 254 may comprise providing a sensory representation of the media content in the reconstructed multimedia file segment 254. For example, the reconstructed multimedia file segment 254 may comprise a movie, and playing the reconstructed multimedia file segment 254 may comprise outputting video, animation, text, or images to a visual display (e.g., a screen or monitor), outputting audio to an auditory device (e.g., speakers or headphones), etc.

In one configuration, playing the reconstructed multimedia file segment 254 may comprise determining the media format of the media encoded in the multimedia file segment 212. For example, audio content may use Advanced Audio Coding (AAC), MPEG-2 Audio Layer III (MP3), Windows Media Audio (WMA), etc. Those of skill in the art will understand that there are a wide variety of multimedia formats and that any format, now known or later developed, may be used. Playing the reconstructed multimedia file segment 254 may further comprise using an appropriate codec for the media format to generate a data stream that may be used to output the media content to an output device.

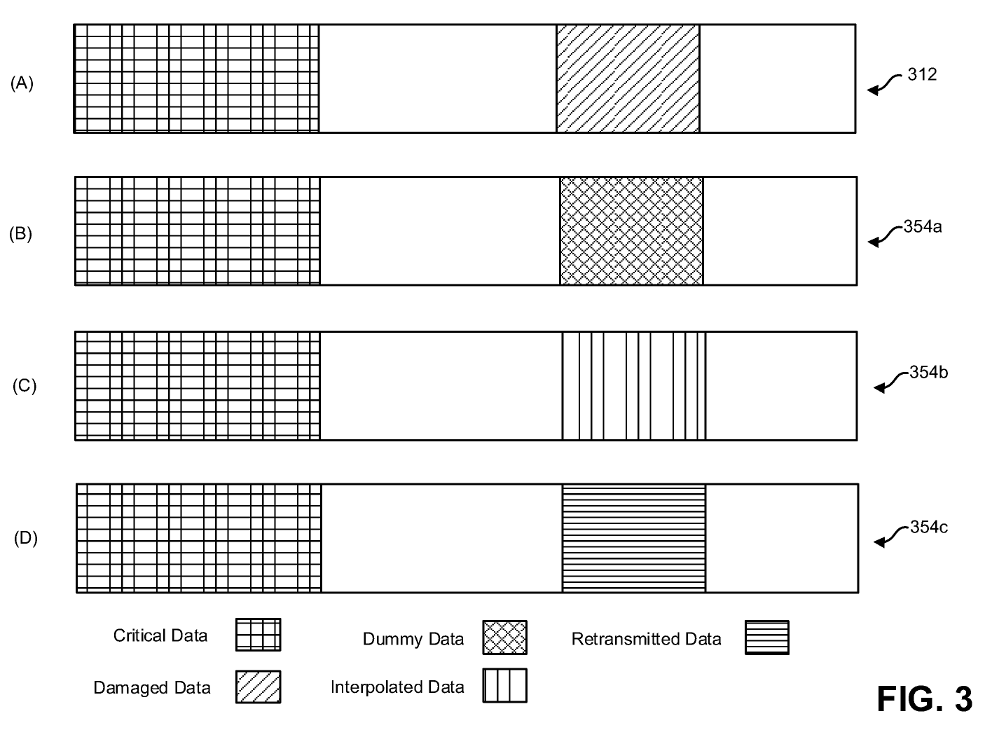

FIG. 3 is a block diagram illustrating some exemplary multimedia file segments.

FIG. 3A illustrates a received multimedia file segment 312 that comprises critical data and damaged data. The received multimedia file segment 312 may have been sent by a content server 110 over a network 130 to a communication device 240. During the transmission process, a portion of the multimedia file segment 312 may have been lost or corrupted, resulting in damaged data. The communication device 240 may analyze the received multimedia file segment 312 and determine that critical parts of the multimedia file segment 312 were received. For example, the communication device 240 may determine that the damaged data does not comprise critical parts of the received multimedia file segment 312.

Further, although FIG. 3A illustrates a multimedia file segment 312 that comprises critical data, those of skill in the art will understand that not every multimedia file segment 312 may include critical data. For example, one multimedia file segment 312 may include the critical data for one or more other multimedia file segments 312. In such a case, the one or more other multimedia file segments 312 may not include critical data.

FIG. 3B illustrates a first reconstructed multimedia file segment 354a. The first reconstructed multimedia file segment 354a may have been reconstructed using the received multimedia file segment 312 and dummy data. For example, the communication device 240 may determine damaged data information 266 about the received multimedia file segment 312. The communication device 240 may use the received multimedia file segment 312 and the damaged data information 266 to generate dummy data. The communication device 240 may then generate the first reconstructed multimedia file segment 354a by replacing the damaged data in the received multimedia file segment 312 with the dummy data.

FIG. 3C illustrates a second reconstructed multimedia file segment 354b. The second reconstructed multimedia file segment 354b may have been reconstructed using the received multimedia file segment 312 and interpolated data. For example, the communication device 240 may determine damaged data information 266 about the received multimedia file segment 312. The communication device 240 may use the received multimedia file segment 312 and the damaged data information 266 to generate interpolated data. The communication device 240 may then generate the second reconstructed multimedia file segment 354b by replacing the damaged data in the received multimedia file segment 312 with the interpolated data.

FIG. 3D illustrates a third reconstructed multimedia file segment 354c. The third reconstructed multimedia file segment 354c may have been reconstructed using the received multimedia file segment 312 and one or more repair data segments 222. For example, the communication device 240 may determine damaged data information 266 and priority information 250 about the received multimedia file segment 312. The communication device 240 may use priority information 250 to send a request over the network 130 to the repair server 120 to send one or more repair data segments 222. The communication device 240 may receive the one or more repair data segments 222 over the network 130 from the repair server 120. The repair data segments 222 may comprise the original data contained in the damaged data. The repair data segments 222 may also comprise error correction code that the communication device 240 may use to generate the original data contained in the damaged data. In another alternative, the repair data segments 222 may comprise the original data contained in the damaged data but in a higher or lower quality. The communication device 240 may generate the third reconstructed multimedia file segment 354c by replacing the damaged data in the received multimedia file segment 312 with the original data obtained from the one or more repair data segments 222.

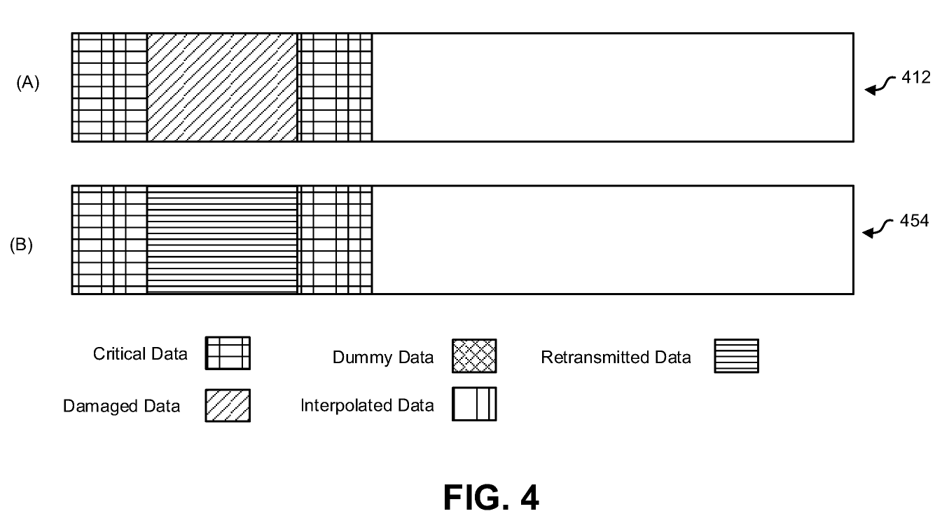

FIG. 4 is a block diagram illustrating some additional exemplary multimedia file segments.

FIG. 4A illustrates a received multimedia file segment 412 that comprises critical data and damaged data. The received multimedia file segment 412 may have been sent by a content server 110 over a network 130 to a communication device 240. During the transmission process, a portion of the multimedia file segment 412 may have been lost or corrupted, resulting in damaged data. The communication device 240 may analyze the received multimedia file segment 412 and may determine that critical parts of the multimedia file segment 412 were not received. For example, the communication device 240 may determine that the damaged data comprises critical parts of the received multimedia file segment 412. Because the critical data for the multimedia file segment 412 was not received, the communication device 240 may drop the multimedia file segment 412. Alternatively, the communication device 240 may request repair data segments 222 from a repair server 120 to compensate for the damaged critical data.

FIG. 4B illustrates a reconstructed multimedia file segment 454. The reconstructed multimedia file segment 454 may have been reconstructed using the received multimedia file segment 412 and one or more repair data segments 222. For example, the communication device 240 may determine damaged data information 266 and priority information 250 about the received multimedia file segment 412. The communication device 240 may use priority information 250 to send a request over the network 130 to the repair server 120 to send one or more repair data segments 222. The communication device 240 may receive the one or more repair data segments 222 over the network 130 from the repair server 120. The repair data segments 222 may comprise the original data contained in the damaged data. Alternatively, the repair data segments 222 may comprise error correction code that the communication device 240 may use to generate the original data contained in the damaged data. In another alternative, the repair data segments 222 may comprise the original data contained in the damaged data but in a higher or lower quality. The communication device 240 may generate the reconstructed multimedia file segment 454 by replacing the damaged data in the received multimedia file segment 412 with the original data obtained from the one or more repair data segments 222.

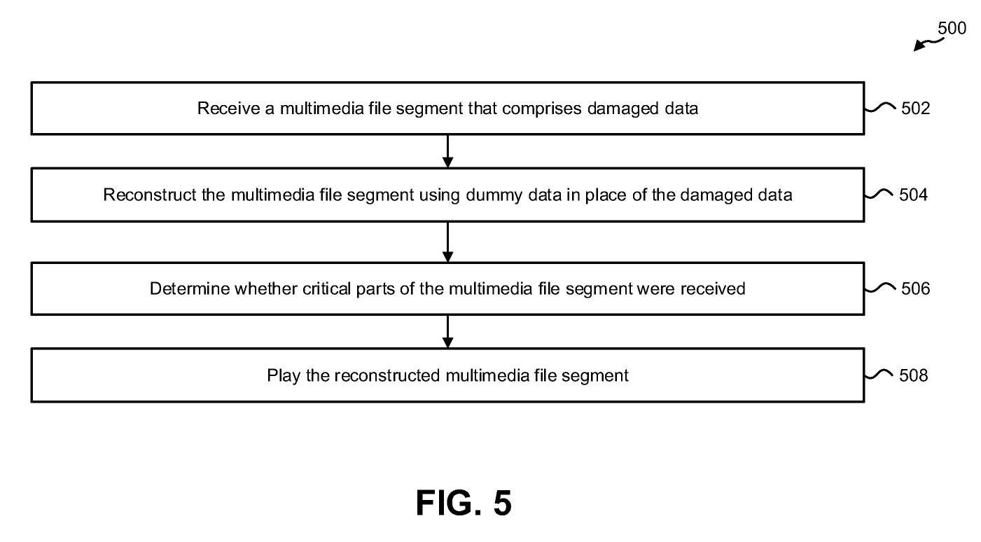

FIG. 5 is a flow diagram illustrating one method 500 for recovering data in multimedia file segments 212. A communication device 240 may receive 502 a multimedia file segment 212 that comprises damaged data. For example, a content server 110 may send the multimedia file segment 212 to the communication device 240 over a network 130. During the transmission process, part of the multimedia file segment 212 may be corrupted or part of the multimedia file segment 212 may be lost. Thus, when the communication device receives the multimedia file segment 212, the multimedia file segment 212 may comprise damaged data.

The communication device 240 may reconstruct 504 the multimedia file segment 212 using dummy data in place of the damaged data. For example, the communication device 240 may generate damaged data information 266 from the multimedia file segment 212 that indicates the presence, size or length, and location of the damaged data in the multimedia file segment 212. The communication device 240 may use this damaged data information 266 to generate dummy data. The communication device 240 may use this dummy data to generate a reconstructed multimedia file segment 254 by replacing the damaged data with the dummy data.

The communication device 240 may determine 506 whether critical parts of the multimedia file segment 212 were received. For example, the communication device 240 may use the multimedia file segment 212 and the damaged data information 266 to determine whether the damaged data comprises critical parts. In another example, the communication device 240 may determine whether critical parts of the multimedia file segment 212 were received in one or more different multimedia file segments 212.

The communication device 240 may play 508 the reconstructed multimedia file segment 254. For example, the reconstructed multimedia file segment 254 may comprise a movie, and playing the reconstructed multimedia file segment may comprise outputting video, animation, text, or images to a visual display (e.g., a screen or monitor), outputting audio to an auditory device (e.g., speakers or headphones), etc.

In one configuration, the communication device 240 may only play the reconstructed multimedia file segment 254 if the communication device 240 positively determines that critical parts of the multimedia file segment 212 were received. For example, if the communication device 240 is unable to play the reconstructed multimedia file segment 254 because critical parts have not been received, the communication device 240 may discard the multimedia file segment 212.

In another configuration, playing the reconstructed multimedia file segment 254 may comprise playing the reconstructed multimedia file segment 254 until a location of the damaged data is reached. For example, the communication device 240 may play the media content encoded in the undamaged data preceding the damaged data until it reaches the beginning of the damaged data.

In still another configuration, playing the reconstructed multimedia file segment 254 may comprise skipping locations of the damaged data. For example, the communication device 240 may play the media content encoded in the undamaged data that precedes damaged data until it reaches the damaged data and then skip to the next portion of undamaged data and continue playing the media content.

In yet another configuration, playing the reconstructed multimedia file segment 254 may comprise playing the dummy data in place of the damaged data. For example, the communication device 240 may play the media content encoded in the undamaged data that precedes the damaged data. Then, when it reaches the location of the damaged data, it may play the dummy data. The dummy data may be played for the same temporal duration as the damaged data would occupy were it not damaged. Playing dummy data may be less disruptive even though it may not output the correct media content because it may allow for continuous playback of the reconstructed multimedia file segment 254.

In still another configuration, playing the reconstructed multimedia file segment 254 may comprise replacing the damaged data with data interpolated from undamaged parts of the multimedia file segment 212. For example, the communication device 240 may use the damaged data information and the multimedia file segment 212 to generate interpolated data. The communication device 240 may play the media content encoded in the undamaged data that precedes the damaged data. Then, when it reaches the location of the damaged data, it may play the interpolated data. Playing interpolated data may allow for continuous playback of the reconstructed multimedia file segment 254 and may be less disruptive because the interpolated data may approximate the correct media content of the damaged data.

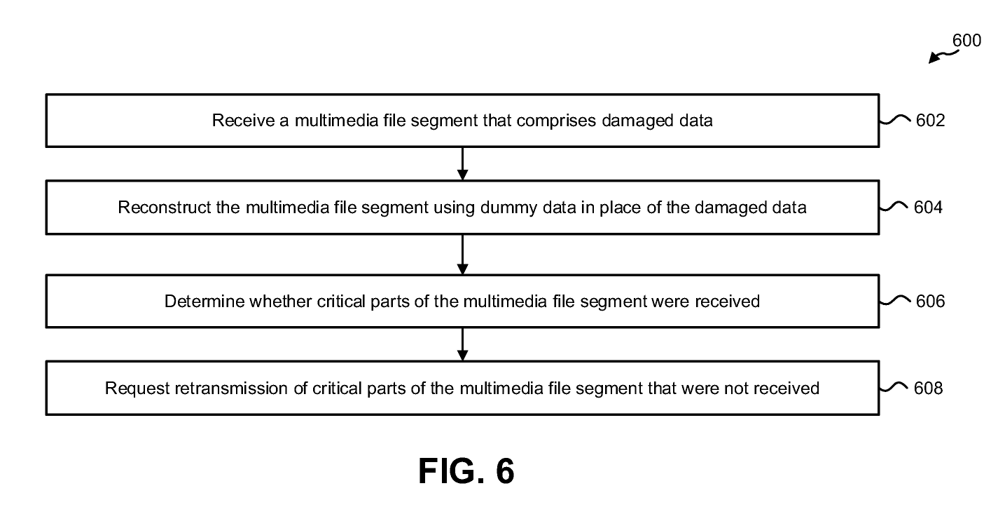

FIG. 6 is a flow diagram illustrating another configuration of a method 600 for recovering data in multimedia file segments 212. A communication device 240 may receive 602 a multimedia file segment 212 that comprises damaged data. For example, a content server 110 may send the multimedia file segment 212 to the communication device 240 over a network 130. During the transmission process, part of the multimedia file segment 212 may be corrupted or part of the multimedia file segment 212 may be lost. Thus, when the communication device 240 receives the multimedia file segment 212, the multimedia file segment 212 may comprise damaged data.

The communication device 240 may reconstruct 604 the multimedia file segment 212 using dummy data in place of the damaged data. For example, the communication device 240 may generate damaged data information 266 from the multimedia file segment 212 that indicates the presence, size or length, and location of the damaged data in the multimedia file segment 212. The communication device 240 may use this damaged data information 266 to generate dummy data. The communication device 240 may use this dummy data to generate a reconstructed multimedia file segment 254 by replacing the damaged data with the dummy data.

The communication device may determine 606 whether critical parts of the multimedia file segment 212 were received. For example, the communication device 240 may use the multimedia file segment 212 and the damaged data information 266 to determine whether the damaged data comprises critical parts. In another example, the communication device 240 may determine whether critical parts of the multimedia file segment 212 were received in one or more different multimedia file segments 212.

The communication device 240 may request 608 retransmission of critical parts of the multimedia file segment 212 that were not received. For example, the communication device 240 may generate priority information 250 based on the damaged data information 266 and whether the damaged data comprises critical data. The priority information 250 may be used to prioritize the retransmission requests. Data that has a high priority may be requested before data with a lower priority. Data with a higher priority may also be requested at a lower quality to reduce latency. In one configuration, the communication device 240 may request retransmission of the original data. In another configuration, the communication device 240 may request retransmission of error-correction codes that the communication device 240 may use with the non-damaged parts of the multimedia file segment 212 to generate the original data.

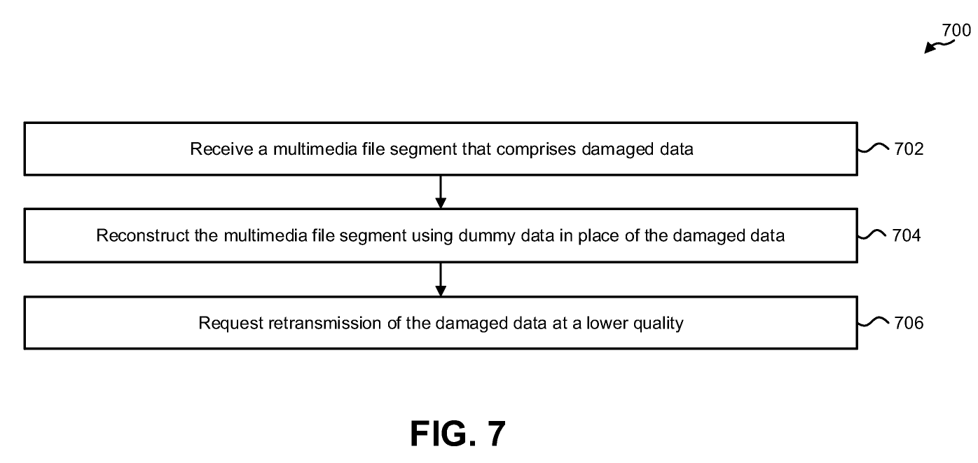

FIG. 7 is a flow diagram illustrating another configuration of a method 700 for recovering data in a multimedia file segment 212. A communication device 240 may receive 702 a multimedia file segment 212 that comprises damaged data. For example, a content server 110 may send the multimedia file segment 212 to the communication device 240 over a network 130. During the transmission process, part of the multimedia file segment 212 may be corrupted or part of the multimedia file segment 212 may be lost. Thus, when the communication device 240 receives the multimedia file segment 212, the multimedia file segment 212 may comprise damaged data.

The communication device 240 may reconstruct 704 the multimedia file segment 212 using dummy data in place of the damaged data. For example, the communication device 240 may generate damaged data information 266 from the multimedia file segment 212 that indicates the presence, size or length, and location of the damaged data in the multimedia file segment 212. The communication device may use this damaged data information 266 to generate dummy data. The communication device may use this dummy data to generate a reconstructed multimedia file segment 254 by replacing the damaged data with the dummy data.

The communication device 240 may request 706 retransmission of the damaged data at a lower quality. The lower quality segments may represent the same portions of the media content as the original data, but may be smaller and less computationally complex. This may allow the communication device 240 to request and receive the repair data segments 222 in time to provide continuous playback of the reconstructed multimedia file segment 254.

Media content may be encoded at higher or lower qualities. Content encoded at a higher quality may be larger, and as a result, may take more time to transmit and may be more computationally complex to decode. On the other hand, content encoded at a lower quality may be smaller, and as a result, may take less time to transmit and be less computationally complex to decode.

Multimedia file segments 212 generated from content encoded at higher and lower qualities may be temporally aligned such that a communication device 240 may use any quality of multimedia file segment 212 to produce continuous playback of the media content. For example, a communication device 240 may use a higher quality multimedia file segment 212 to play the first five seconds of media content. It may then use a lower quality multimedia file segment 212 to play the next five seconds of media content. In another example, the communication device 240 may use a lower quality multimedia file segment 212 to play the first five seconds of media content and a higher quality multimedia file segment 212 to play the next five seconds of media content.

A communication device 240 may request multimedia file segments 212 encoded at higher or lower qualities based on the current conditions experienced by the communication device 240. For example, the communication device 240 may request lower quality multimedia file segments 212 when network throughput is low or when computational resources on the communication device 240 are busy with other tasks. In another example, the communication device 240 may request higher quality multimedia file segments 212 when network throughput is high or when computational resources on the communication device 240 are available.

Thus, in one configuration, requesting retransmission of the damaged data at a lower quality may comprise requesting a lower quality multimedia file segment 212 for the same media content contained in the higher quality multimedia file segment 212. Or, in another configuration, requesting retransmission of the damaged data at a lower quality may comprise requesting repair data segments 222 that comprise only the portions of the lower quality multimedia file segment 212 for the same media content needed to replace the damaged data.

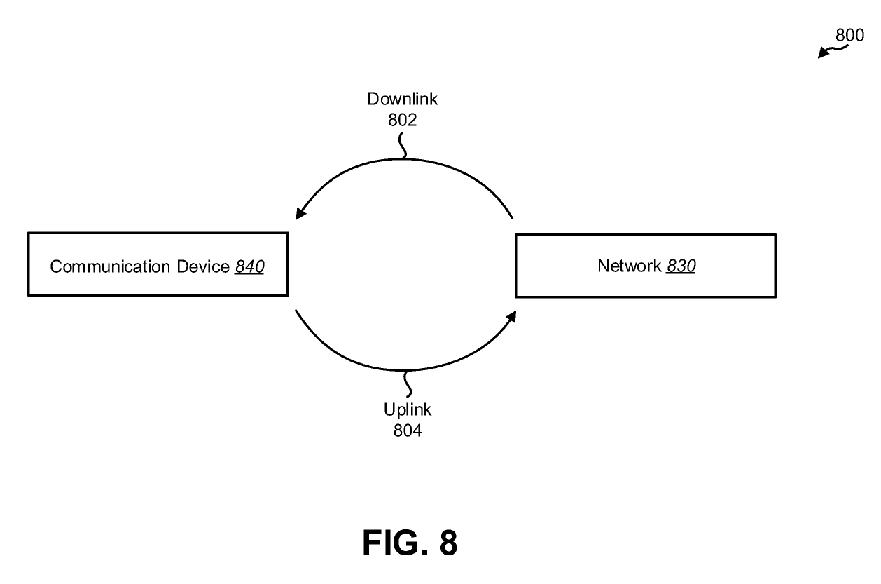

As discussed above, the communication device 240 may communicate over wired or wireless systems using any suitable protocols and standards. FIGS. 8-14 illustrate an exemplary configuration of a communication device 240 that utilizes the dynamic adaptive streaming over hypertext transfer protocol (DASH) and file delivery over unidirectional transport (FLUTE) protocols in an LTE wireless communication system. The following description, however, does not limit the invention to these particular standards and protocols. Rather, it provides an example of how the invention may be used in one context.

FIG. 8 is a block diagram illustrating a wireless communication system 800 that may be used in one configuration of the present invention. Wireless communication systems are widely deployed to provide various types of communication content such as voice, data, etc. The wireless communication system 800 includes a communication device 840 in communication with a network 830. The communication device 840 may communicate with the network via transmissions on the downlink 802 and the uplink 804. The downlink 802 (or forward link) may refer to the communication link from network 830 to communication device 840, and the uplink 804 (or reverse link) may refer to the communication link from the communication device 840 to the network 830.

The network 830 may include one or more base stations. A base station is a station that communicates with one or more communication devices 840. A base station may also be referred to as, and may include some or all of the functionality of, an access point, a broadcast transmitter, a NodeB, an evolved NodeB, etc. Each base station provides communication coverage for a particular geographic area. A base station may provide communication coverage for one or more communication devices 840. The term “cell” can refer to a base station and/or its coverage area depending on the context in which the term is used.

Communications in a wireless system 800 (e.g., a multiple-access system) may be achieved through transmissions over a wireless link. Such a communication link may be established via a single-input and single-output (SISO), multiple-input and single-output (MISO), or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity, or improved reliability) if the additional dimensionalities created by the multiple transmit and receive antennas are utilized.

The wireless communication system 800 may utilize MIMO. A MIMO system may support both time division duplex (TDD) and frequency division duplex (FDD) systems. In a time division duplex (TDD) system, uplink and down-link transmissions are in the same frequency region so that the reciprocity principle allows the estimation of the downlink channel from the uplink channel. This enables a transmitting wireless device to extract transmit beamforming gain from communications received by the transmitting wireless device.

The wireless communication system 800 may be a multiple-access system capable of supporting communication with multiple communication devices 840 by sharing the available system resources (e.g., bandwidth and transmit power). Examples of such multiple-access systems include CDMA systems, wideband code division multiple access (W-CDMA) systems, TDMA systems, FDMA systems, OFDMA systems, single-carrier frequency division multiple access (SC-FDMA) systems, 3GPP LTE systems, and spatial division multiple access (SDMA) systems.

The terms “networks” and “systems” may be used interchangeably. A CDMA network may implement a radio technology such as Universal Terrestrial Radio Access (UTRA), cdma2000, etc. UTRA includes W-CDMA and Low Chip Rate (LCR), while cdma2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). LTE is a release of UMTS that uses E-UTRA. UTRA, E-UTRA, GSM, UMTS, and LTE are described in documents from 3GPP. cdma2000 is described in documents from an organization named “3rd Generation Partnership Project 2” (3GPP2).

A communication device 840 may also be referred to as, and may include some or all of the functionality of a terminal, an access terminal, a user equipment, a subscriber unit, a station, etc. A communication device 840 may be a cellular phone, a smartphone, a personal digital assistant (PDA), a wireless device, a wireless modem, a handheld device, a laptop computer, etc.

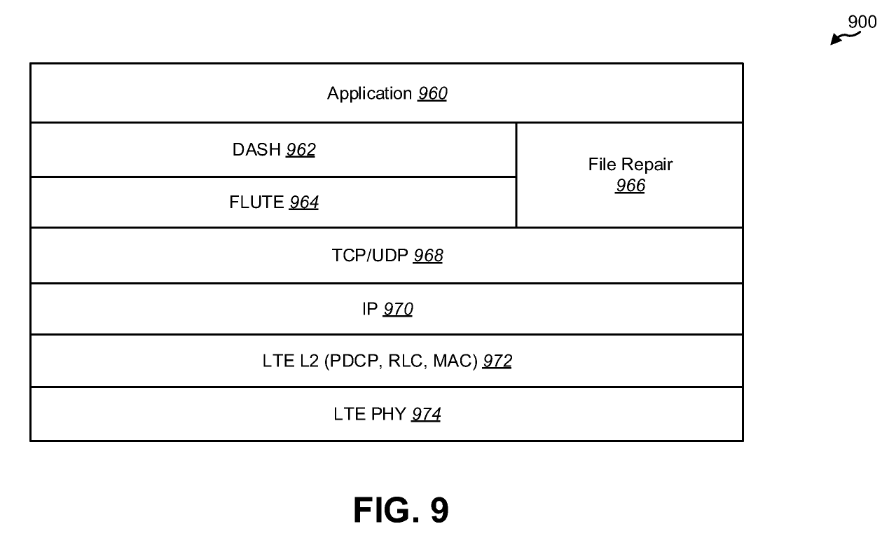

FIG. 9 is a block diagram illustrating an exemplary protocol layer stack 900 that may be used in one configuration the present invention.

The 3GPP LTE release 9 provides support for evolved multimedia broadcast multicast service (eMBMS) in the LTE air interface to enable streaming video broadcasts and file download services.

In the exemplary protocol layer stack 900, multimedia content may be transported using the dynamic adaptive streaming using hypertext transfer protocol (HTTP) (DASH) protocol 962 over file delivery over unidirectional transport (FLUTE) 964 as defined in the Internet Engineering Task Force (IETF) request for comments (RFC) 3926. The protocol layer stack may also include a transmission control protocol (TCP) or user datagram protocol (UDP) layer 968; an Internet protocol (IP) layer 970; an LTE layer 2 (L2) 972, which may use packet data convergence protocol (PDCP), radio link control (RLC), or medium access control (MAC); and an LTE physical (PHY) layer 974.

In the exemplary protocol layer stack, various protocol layers may provide repair functionality, e.g., TCP/IP, forward error correction (FEC), HTTP-based request and response, etc. The file repair functionality may use the file repair 966 layer.

A multimedia file segment transported using the DASH protocol (i.e., a DASH multimedia file segment) may comprise video or audio media content that may be accumulated for some time duration, e.g., one second or a few seconds. Video media content may be encoded using any suitable codec, for example, advanced video coding (H.264). Audio media content may be encoded using any suitable codec, for example, advanced audio coding (AAC). Those of skill in the art will understand that there are a wide variety of multimedia codecs and that any codec, now known or later developed, may be used. The size of the DASH multimedia file segment may change depending on the bit rate and the content temporal variation.

A DASH multimedia file segment may be fragmented for transport over one or more FLUTE packets. Each FLUTE packet may be carried by a user datagram protocol (UDP)/IP packet and may be sent to a communication device 840 over a network 830. For example, a FLUTE packet may use the LTE air interface, including the LTE RLC, MAC, and PHY layers.

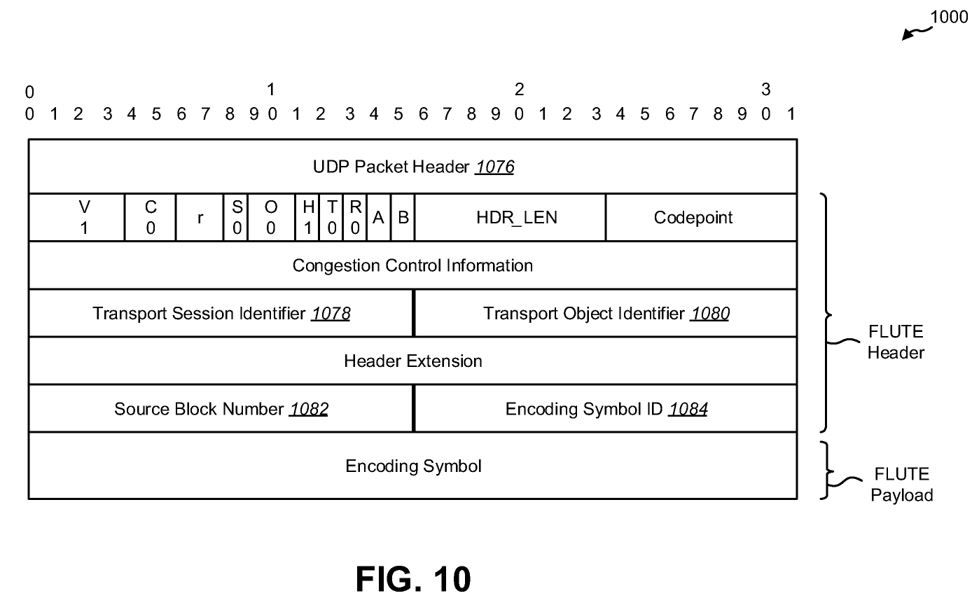

FIG. 10 is a block diagram illustrating an exemplary FLUTE over UDP packet 1000. The exemplary FLUTE packet 1000 may include a UDP Packet Header 1076. In the exemplary FLUTE packet 1000, the transport session identifier (TSI) 1078 and transport object identifier (TOI) 1080 fields may be used to uniquely identify a DASH multimedia file segment. The source block number 1082 and encoding symbol ID 1084 fields may be used to uniquely identify a FLUTE packet 1000 within the DASH multimedia file segment.

If FLUTE packets 1000 are damaged during the transmission process, a communication device 840 may use error-correction techniques to attempt to recover the damaged packets. For example, in one configuration, the communication device 840 may use forward error correction (FEC). Several FEC schemes are available, including Raptor (described in IETF RFC 5053), RaptorQ (described in IETF RFC 6330), etc. In FEC, the content server may transmit FEC repair symbols in addition to FEC source symbols. FEC source symbols may include portions of the DASH multimedia file segment. FEC repair symbols may include additional data that may be used to repair damaged FEC source symbols. The communication device 840 may attempt to recover the damaged FEC source symbols using the FEC repair symbols. In another configuration, a recovery scheme that avoids FEC encoding and decoding may be used to reduce the processing delay, such as Compact No-Code FEC (described in IETF RFC 3695). Those of skill in the art will understand that there are a wide variety of error-correction techniques and that any technique, now known or later developed, may be used.

In addition to transporting DASH multimedia file segments, the FLUTE protocol may provide in-band signaling of the properties of delivered multimedia files using a file delivery table (FDT) packet. An FDT packet may be a special FLUTE packet 1000 with the TOI 1080 set to zero. An FDT packet may carry information such as a uniform resource identifier (URI) of the file and an associated TOI 1080 value, a length of the multimedia content (content-length), a type of the multimedia content (content-type), an FEC encoding ID, FEC object transmission information (OTI), etc. For example, in one configuration that uses Raptor FEC, the OTI may comprise F, Al, T, N, and Z. F may be the file size in bytes. Al may be an alignment factor that may be used to ensure symbols and sub-symbols are aligned on a byte boundary (typically four or eight bytes). N and Z may be the number of sub-blocks per source block and the number of source blocks, respectively.

The communication device 840 may receive FLUTE packets 1000 over the network 830. The communication device 840 may examine an FEC payload ID (i.e., a source block number (SBN) 1082 and encoding symbol ID (ESI) 1084) to determine how the FEC source and FEC repair symbols in the FLUTE packet 1000 were generated from the DASH multimedia file segment. Based on the FEC payload ID and the FEC OTI, the communication device 840 may determine the partition structure of the DASH multimedia file segment in source blocks, sub-blocks, and symbols and sub-symbols. In this manner, the communication device 840 may use the FEC OTI and the FEC payload ID to determine the bytes contained in the FLUTE packet 1000 for the FEC source symbols, or to determine how the bytes in the FLUTE packet 1000 were generated for FEC repair symbols.

In another configuration, a communication device 840 may use feedback-based repair mechanisms. The communication device 840 may determine that a FLUTE packet 1000 is damaged. The communication device 840 may request retransmission of the data or symbols contained in the damaged FLUTE packet 1000. For example, the communication device 840 may send an HTTP GET Request message with the message body including the uniform resource identifier (URI) of the multimedia file and information identifying the data or symbols contained in the damaged FLUTE packet 1000. The data contained in the damaged FLUTE packet 1000 may be retransmitted in an HTTP Response message. In one configuration, the HTTP Request and Response messages may be transported using TCP/IP over an LTE unicast link.

In another configuration using a feedback-based repair mechanism, after performing FEC, the communication device 840 may determine the portions of the DASH multimedia file segment that comprise damaged data, the FEC source or FEC repair symbols needed to recover the damaged data (this may be substantially less than all of the damaged data because there may be some FEC repair symbols that were previously received but were not used), the portions of the DASH multimedia file segment to be reconstructed, and the portions of the FEC repair symbols that may be used to further recover the multimedia file segment. The communication device 840 may then use the HTTP protocol to request FEC source and repair symbols to recover the damaged data.

If the communication device 840 is unable to recover any of the DASH multimedia file segment after FEC, then the above procedure may be simplified. The communication device may determine that the entire DASH multimedia file segment is damaged and that (K−R+delta)×T more bytes of FEC source symbols are needed to recover the DASH multimedia file segment. In this equation, K may be the number of FEC source symbols in the file, R may be the number of FEC repair symbols received through FLUTE delivery, delta may be a prescribed overhead safety factor to guarantee high probability FEC decoding (e.g., delta=2 may guarantee a decoding failure probability of at most 1×10⁻⁶), and T may be the symbol size. Because none of the DASH multimedia file segments are reconstructed, all R×T bytes of FEC repair symbols received through FLUTE delivery may be stored, awaiting further recovery. HTTP recovery then may involve requesting FEC source symbols for the first (K−R+delta)×T of the DASH multimedia file segment and combining the FEC source symbols with the previously received FEC repair symbols to recover the file.

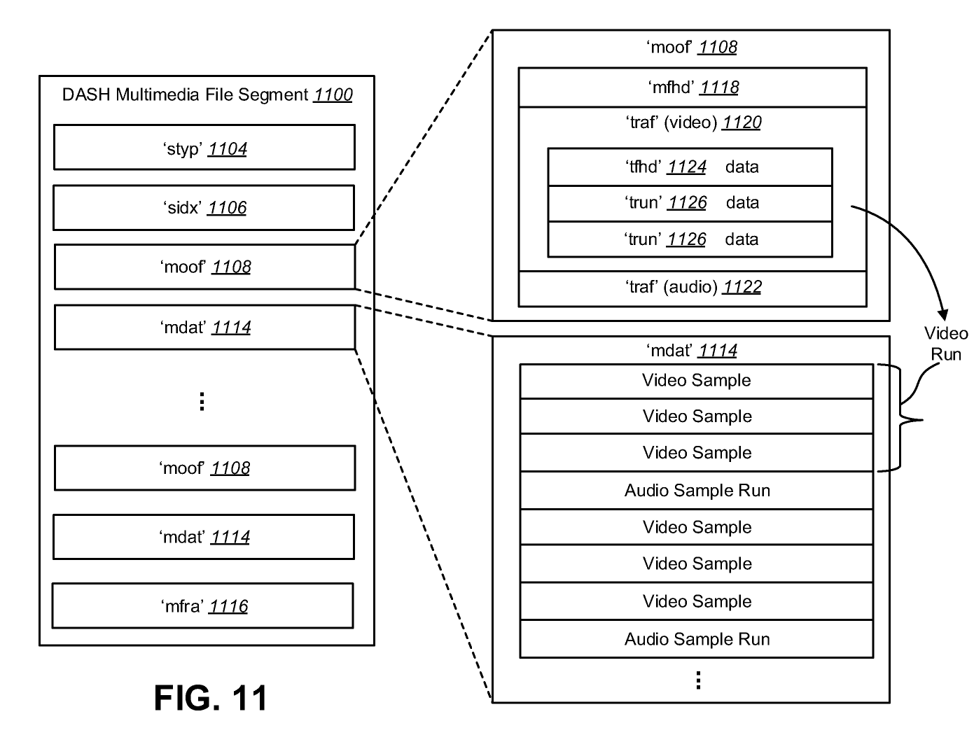

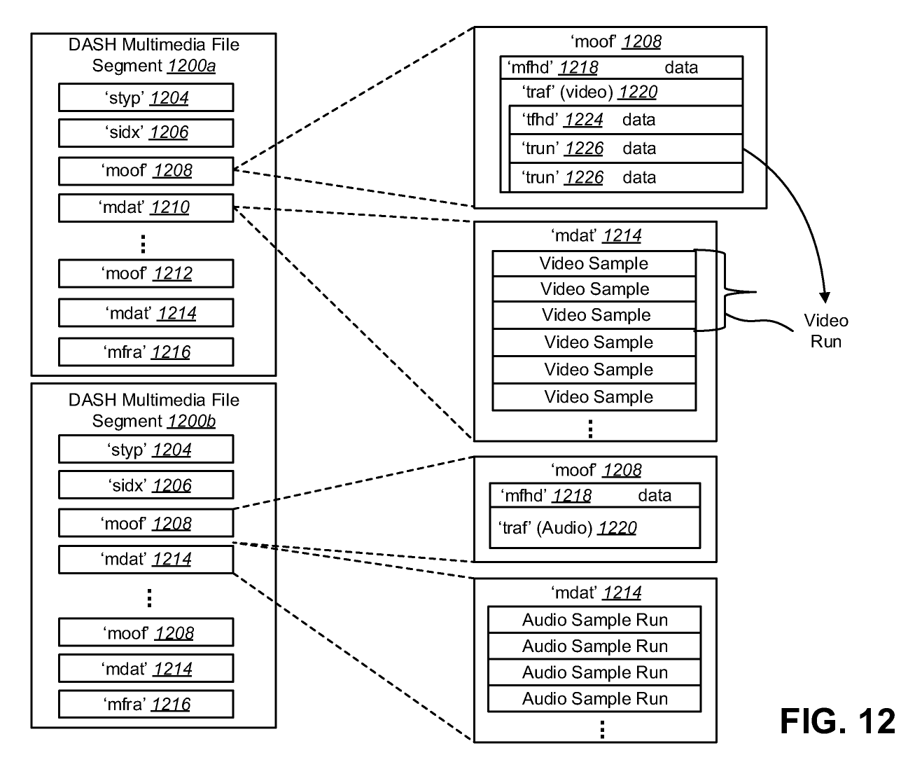

FIGS. 11 and 12 are block diagrams illustrating exemplary DASH multimedia file segments 1100, 1200a, 1200b. The DASH protocol may be used to carry video or audio media content in a DASH multimedia file segment 1100, 1200a, 1200b. In FIG. 11, an exemplary DASH multimedia file segment 1100 is shown in which video and audio media content are multiplexed in the same DASH multimedia file segment 1100. In FIG. 12, two exemplary DASH multimedia file segments 1200a, 1200b are shown in which video media content is transported in one DASH multimedia file segment 1200a and audio media content is transported in a different DASH multimedia file segment 1200b.

DASH multimedia file segments 1100, 1200a, 1200b may contain the following boxes:

| | | | Description |
|---|---|---|---|
| Name of boxes (in hierarchical order) | | | of boxes |
| ‘styp’ 1104, 1204 | | | Segment type |
| ‘sidx’ 1106, 1206 | | | Segment index |
| ‘moof’ 1108, 1208 | | | Movie fragment |
| | ‘mfhd’ 1118, 1218 | | Movie fragment |
| | | | header |
| | ‘traf’ 1120, 1220 | | Track fragment |
| | | ‘tfhd’ 1124, 1224 | Track fragment |
| | | | header |
| | | ‘trun’ 1126, 1226 | Track fragment |
| | | | run |
| ‘mdat’ 1114, 1214 | | | Media data |
| | | | container |
| ‘mfra’ 1116, 1216 | | | Movie fragment |
| | | | random access |
| | ‘tfra’ | | Track fragment |
| | | | random access |
| | ‘mfro’ | | Movie fragment |
| | | | random access |
| | | | offset |

According to the DASH protocol, boxes may start with a header that describes a size and type. The header may permit compact or extended sizes (e.g., 32 or 64 bits) and compact or extended types (e.g., 32 bits or full Universal Unique Identifiers (UUIDs)). Most boxes, including standard boxes, may use compact types (32 bit). In one configuration, media data container boxes (‘mdat’) 1114, 1214 may be the only box that uses the 64-bit size. The size may be the size of the entire box, including the header, fields, and contained boxes. This may facilitate general parsing of the file.

The movie fragment (‘moof’) 1108, 1208 and ‘mdat’ 1114, 1214 boxes may come in a pair because ‘mdat’ 1114, 1214 may contain the media content with one fragment as described in one ‘moof’ box 1108, 1208. In video streaming, for example, there may be only one pair of ‘moof’ 1108, 1208 and ‘mdat’ 1114, 1214 boxes.

The movie fragment random access (‘mfra’) box 1116, 1216 may provide a table that may assist the communication device 840 in finding random access points in the DASH multimedia file segment 1100, 1200a, 1200b using movie fragments. It may contain a track fragment random access (‘tfra’) box for each track provided (which may not be all tracks). This may be useful if the prior DASH multimedia file segment 1100, 1200a, 1200b is damaged or playback begins in the middle of a streaming video. The ‘mfra’ box 1116, 1216 may be placed at or near the end of the DASH multimedia file segment 1100, 1200a, 1200b. The last box within the ‘mfra’ box 1116, 1216 may provide a copy of the length field.

As mentioned above, one or more FLUTE packets 1000 may be damaged during the transmission process. This may cause the communication device 840 to drop the entire DASH multimedia file segment 1100, 1200a, 1200b. This in turn, for example, may result in media content freezing or blanking during playback. This may be a disadvantage of DASH-based streaming; namely, the loss of one FLUTE packet 1000 may cause the loss of a whole DASH multimedia file segment 1100, 1200a, 1200b. Further, although FEC may be used to improve overall performance, a communication device 840 may still not receive enough symbols to successfully decode the multimedia file segment 1100, 1200a, 1200b.

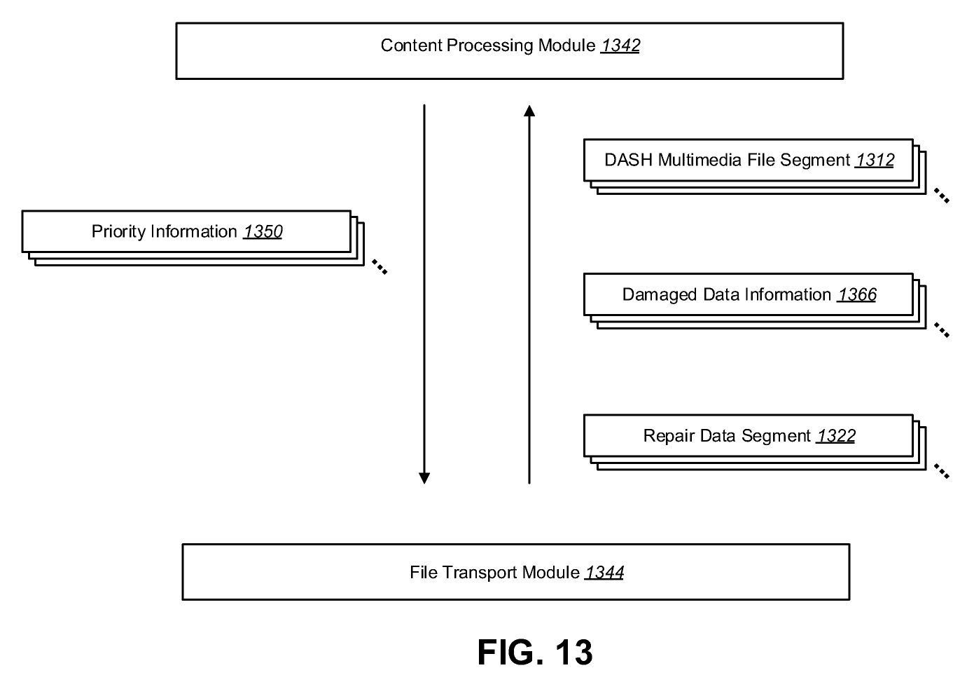

FIG. 13 is a block diagram illustrating the interface between a file transport module 1344 and a content processing module 1342 on a communication device 840 in a configuration that uses the DASH and FLUTE protocols. The file transport module 1344 may be used to request and receive DASH multimedia file segments 1312 and repair data segments 1322 over the network 830. The file transport module 1344 may correspond to the LTE 972, 974; TCP/UDP/IP 968, 970; and FLUTE 964 layers in the exemplary protocol layer stack 900. The file transport module 1344 may also include FEC or other file-repair functions 966. The content processing module 1342 may be used to reconstruct and play DASH multimedia file segments 1312. The content processing module 1342 may correspond to the DASH 962 or application layers 960 in the exemplary protocol stack 900.

The interface between the file transport module 1344 and the content processing module 1342 may support the following functions. The file transport module 1344 may provide DASH multimedia file segments 1312 to the content processing module 1342. The DASH multimedia file segments 1312 may comprise damaged data. The file transport module 1344 may provide additional damaged data information 1366. For example, for a one megabyte DASH multimedia file segment 1312, the interface may indicate that the first 500 kilobytes were received or corrected, the next 20 kilobytes were damaged and not corrected, and the last 480 kilobytes were received or corrected. The content processing module 1342 may provide priority information 1350 about the damaged data. For example, a high priority may indicate that the damaged data should be repaired or retransmitted more quickly than if the damaged data has a lower priority.

In one configuration, if the content processing module 1342 is capable of processing DASH multimedia file segments 1312 that comprise damaged data, then the content processing module 1342 may process the partially received DASH multimedia file segment 1312. Otherwise, the content processing module 1342 may discard the entire DASH multimedia file segment 1312 with the damaged data.

In one example, the file transport module 1344 may utilize the file type to indicate the presence of a DASH multimedia file segment 1312 that comprises damaged data. A content processing module 1342 without the ability to process partially received DASH multimedia file segments 1312 may then ignore all DASH multimedia file segments 1312 with a filename that indicates that the DASH multimedia file segment 1312 comprises damaged data. The file transport module 1344 may delete any remaining DASH multimedia file segments 1312 that comprise damaged data at the end of a session. The content processing module 1342 may also delete DASH multimedia file segments 1312 that are present for more than a threshold amount of time (e.g., in seconds). For example, the content processing module may delete DASH multimedia file segments 1312 that comprise damaged data that are present for more than a threshold amount of time that reside in the output memory area of DASH Live or DASH Low Latency Live profile service. If the DASH multimedia file segments 1312 are downloaded in the background (i.e., they are not immediately played back), the communication device 840 may comprise a mechanism to delete DASH multimedia file segments that comprise damaged data if the FLUTE stack in the file transport module attempts to write the damaged DASH multimedia file segment.

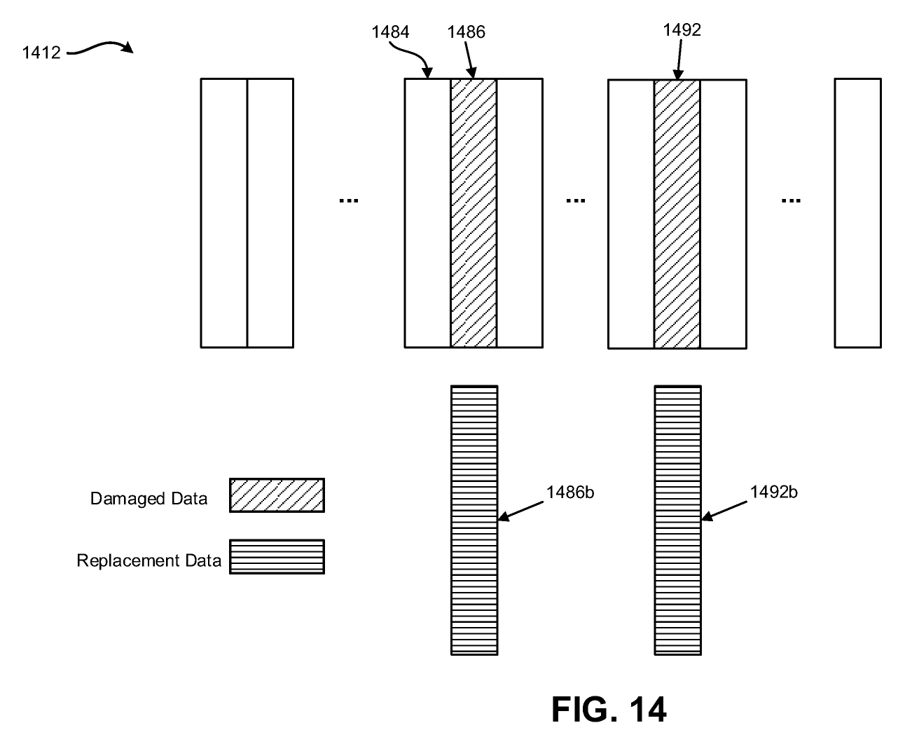

FIG. 14 is a block diagram illustrating a DASH multimedia file segment 1412 comprising one or more damaged FLUTE packets or FEC source symbols 1486, 1492. A communication device 840 receiving this DASH multimedia file segment 1412 may attempt to recover the damaged FLUTE packets or FEC source symbols 1486, 1492 with or without requesting retransmission of the damaged data.

Recovery without Retransmission

The communication device 840 may attempt to recover the damaged data 1486, 1492 without requesting retransmission of the damaged data 1486, 1492. The file transport module 1344 may receive the one or more FLUTE packets or FEC source symbols and apply error correction techniques (e.g., FEC). Even after error correction, the DASH multimedia file segment 1412 may comprise damaged data 1486, 1492. In other words, one or more of the FLUTE packets or FEC source symbols 1486, 1492 may still be damaged. The file transport module 1344 may generate damaged data information 1366 about the DASH multimedia file segment 1412. The file transport module 1344 may provide the DASH multimedia file segment 1412 and the damaged data information 1366 to the content processing module 1342.

The content processing module 1342 may use the DASH multimedia file segment 1412 and the damaged data information 1366 to generate replacement data segments 1486b, 1492b. The content processing module 1342 may use the replacement data segments 1486b, 1492b to replace the damaged FLUTE packets or FEC source symbols 1486, 1492.

In one configuration, the replacement data segments 1486b, 1492b may comprise dummy data. The content processing module 1342 may generate replacement data segments 1486b, 1492b that comprise dummy data. The dummy data may comprise padding with zeros. Further, the content processing module 1342 may avoid creating an illegal pattern. For example, a hash for the multimedia file segment 1412 may indicate that the file contains replacement data segments 1486b, 1492b. In another example, dummy data may be selected that avoids causing a hash-check failure. The content processing module 1342 may also ignore the hash-check results.

The content processing module 1342 may determine whether critical parts of the DASH multimedia file segment 1412 were received. Based on whether the critical parts were received, the content processing module 1342 may take different actions.

In one configuration, the critical parts may include the segment type (‘styp’) box 1104, 1204, the segment index (‘sidx’) box 1106, 1206, and the first movie fragment (‘moof’) box 1108, 1208. If the critical parts were received, then the content processing module 1342 may play the DASH multimedia file segment 1412 until the location 1484 prior to the first damaged FLUTE packet or FEC source symbol 1486. The content processing module may discard the remainder of the DASH multimedia file segment after the location 1484 prior to the first damaged FLUTE packet or FEC source symbol 1486. If the critical parts of the DASH multimedia file segment 1412 were not received, then the entire DASH multimedia file segment 1412 may be discarded.

In another configuration, the damaged data 1486, 1492 may comprise the movie data container box (‘mdat’) 1114, 1214. The communication device 840 may play or skip through the damaged FLUTE packets or FEC source symbols 1486, 1492 until it reaches the end of the ‘mdat’ box 1114, 1214. The communication device 840 may play replacement data 1486b, 1492b that comprises dummy data or interpolated data in place of the damaged FLUTE packets or FEC source symbols 1486, 1492.

In yet another configuration, the damaged data 1486, 1492 may comprise the last Instantaneous Decode Refresh (IDR) frame or most of the data prior to a random access point. An IDR frame may be a special type of I-frame in H.264. An IDR frame may specify that no frame after the IDR frame may reference a frame before an IDR frame. The communication device 840 may attempt to locate the movie fragment random access (‘mfra’) box 1116, 1216 at the end of the DASH multimedia file segment 1412. For example, the communication device 840 may search for the beginning of the ‘mfra’ box 1116, 1216 at a fixed number of bytes (e.g., 128 bytes) from the end of the DASH multimedia file segment 1412. In another example, the communication device 840 may begin searching four bytes from the end of the DASH multimedia file segment 1412 and incrementally move back one byte (i.e., last five bytes, last six bytes, etc.) to determine if the ‘mfra’ box 1116, 1216 can be detected. The communication device 840 may confirm detection of the ‘mfra’ box 1116, 1216 if the first 32 bits of the searched block have length information that matches the size of the searched block. The communication device 840 may further confirm detection based on whether the type field indicates it is an ‘mfra’ box 1116, 1216.

If the communication device 840 locates the ‘mfra’ box 1116, 1216 and the ‘mfra’ box 1116, 1216 is not damaged, the communication device 840 may attempt to play the DASH multimedia file segment 1412. The communication device 840 may skip the media content before the random access point and begin playback at the random access point as indicated by the ‘mfra’ box 1116, 1216. The communication device 840 may continue playing until it reaches damaged data 1486, 1492. If the damaged data 1486, 1492 comprises only the ‘mdat’ box 1114, 1214, the communication device 840 may also replace the damaged data 1486, 1492 with replacement data 1486b, 1492b comprising dummy data and play the media content through the end of the ‘mdat’ box 1114, 1214. The communication device 840 may also use interpolated data as replacement data 1486b, 1492b.

In another configuration, the damaged data 1486, 1492 may comprise multiple FLUTE packets 1000 or FEC source symbols. The communication device may play the media content from the first pair of ‘moof’ 1108, 1208 and ‘mdat’ 1114, 1214 boxes continuously to the following pair of ‘moof’ 1108, 1208 and ‘mdat’ 1114, 1214 boxes until reaching the damaged data 1486, 1492. If the damaged data 1486, 1492 comprises the ‘mdat’ box 1114, 1214 but not the size or type of the ‘mdat’ box 1114, 1214, the communication device 840 may replace the damaged data 1486, 1492 with replacement data 1486b, 1492b comprising dummy data or interpolated data and continue playback beyond the location of the damaged data 1486, 1492.

In still another configuration, video media content and audio media content may be in different DASH multimedia file segments 1412 (e.g., as shown in FIG. 12). In this case, it may be easier to recover damaged data 1486, 1492 in the DASH multimedia file segment 1412 that includes the audio data. For example, audio encoding may enable independent playback at any point in the audio media content. In contrast, video encoding may depend on prior video content (e.g., IDR frames). Consequently, playing video media content may first necessitate recovering damaged data that comprises prior video content. In other words, if the damaged data comprises audio media content, the communication device 840 may begin playback at any point in the non-damaged portions of the DASH multimedia file segment 1412. But, if the damaged data comprises video media content, the communication device 840 may need to recover prior data in order to play subsequent frames.

Recovery with Retransmission

The communication device 840 may also attempt to recover the damaged data 1486, 1492 by requesting retransmission of all or part of a damaged DASH multimedia file segment 1412. The file transport module 1344 may receive the one or more FLUTE packets or FEC source symbols and apply error correction techniques (e.g., FEC). Even after error correction, the DASH multimedia file segment 1412 may comprise damaged data 1486, 1492. The file transport module 1344 may provide the DASH multimedia file segment 1412 and damaged data information 1366 to the content processing module 1342.

The content processing module 1342 may determine that the damaged data 1486, 1492 comprises critical parts of the multimedia file segment 1412. The content processing module 1342 may generate priority information 1350 and provide the priority information 1350 to the file transport module 1344.

The content processing module 1342 may determine that the following data is high priority for a DASH multimedia file segment 1412: control boxes (e.g. ‘styp’ 1104, 1204; ‘sidx’ 1106, 1206; ‘moof’ 1108, 1208; ‘mfra’ 1116, 1216), because control boxes may indicate the control information needed to play the video or audio media content; critical video or audio frames (e.g., IDR frames or other data such as P or reference B frames that modify a buffer during decode), because these frames may affect the decode quality for subsequent frames; or data located earlier in the DASH multimedia file segment 1412, because media content is played from earlier data samples to later data samples.

The file transport module 1344 may request retransmission of the damaged data 1486, 1492 (e.g., FLUTE packets or FEC source symbols). Damaged data 1486, 1492 with a higher priority may be retransmitted more quickly than damaged data 1486, 1492 with a lower priority. Further, the file transport module 1344 may prioritize passing critical data to the content processing module 1342. This may allow the content processing module 1342 to play some data immediately to achieve real-time performance without waiting for retransmission of all the damaged data 1486, 1492.

In one configuration, control boxes (e.g. ‘styp’ 1104, 1204; ‘sidx’ 1106, 1206; ‘moof’ 1108, 1208) may be in the beginning of the DASH multimedia file segment 1412 whose length may be unknown. To prioritize retransmission, the file transport module 1344 may request some range of data. For example, if the first 4000 bytes of data in the file segment are damaged, the communication device 840 may request the first 1000 bytes of data with high priority if the length of the control boxes ‘styp’ 1104, 1204, ‘sidx’ 1106, 1206, and ‘moof’ 1108, 1208 is known to be around 1000 bytes as determined from previously received DASH multimedia file segments 1312.

In another configuration, the file transport module 1344 may request retransmission of reduced quality data. For example, video media content may be transmitted in high quality, e.g., 2 megabits per second (Mbps). The video media content may be broken into five-second segments, where each segment is delivered as a DASH multimedia file segment 1312 over FLUTE. Thus, on average, each DASH multimedia file segment 1312 may be around 10 megabits (1.25 megabytes) in size. If a particular DASH multimedia file segment 1412 is not completely recovered by the file transport module 1344, the communication device 840 may request retransmission of the damaged data 1486, 1492 at a lower quality. In other words, if the amount of data that needs to be recovered is too large, the communication device 840 may request retransmission of a lower quality encoding of the same time slice over HTTP, e.g., download the same five seconds of video, but encoded at a lower quality, for example, 400 kbit/s. Thus, the amount of data downloaded over HTTP would be approximately 250 kilobytes (5 seconds at 400 kbit/s) instead of 1.25 megabytes. The content processing module 1342 may splice in and playback the lower quality video encoded at 400 Kbps for those 5 seconds in the higher quality 2 Mbit/s stream. This may allow a continuous viewing experience for the end user (albeit at lower quality over certain periods of time when the application downloads over HTTP a lower-quality stream). But, this may reduce the amount of data to download, which in turn may reduce the latency of the retransmission.

In another configuration, a layered video codec may be used. For example, the communication device 840 may use H.264 Scalable Video Coding (SVC). In H.264 SVC, a base layer may be encoded at 1 Mbit/s and an enhancement layer encoded at 1 Mbit/s. Both layers may be transmitted using DASH multimedia file segments 1312, either as one DASH multimedia file segment 1312 per time slice comprising both the base and enhancement layers, or as two DASH multimedia file segments 1312 per time slice, wherein one DASH multimedia file segment 1312 comprises the base layer and the other DASH multimedia file segment 1312 comprises the enhancement layer. In either case, if either the base or enhancement layers is damaged, then the content processing module 1342 may: fill in the damaged data with null bytes if this will not have too large of an impact on the quality of the playback; interpolate the damaged using the video decoder from other parts of the DASH multimedia file segments 1312; request retransmission of only the base layer via HTTP; or request retransmission of both the base layer and the enhancement layers via HTTP unicast.

In one configuration, the retransmission may be delayed for some time to avoid a correlated error in the radio interface with the initial transmission. A channel decorrelation time of 0.5 seconds may be possible and a back-off time of at least half a second may be needed.

The present invention may thus allow a user equipment to recover critical data or use multimedia file segments that comprise damaged data to play media content during eMBMS streaming. It may improve the user experience when the communication device 840 otherwise may have discarded an entire multimedia file segment 1312 due to damaged data. It may be used for unicast multimedia content streaming. It may also be used for file transfer services. It may also be used to obtain data from a local cache or in a peer-to-peer network.

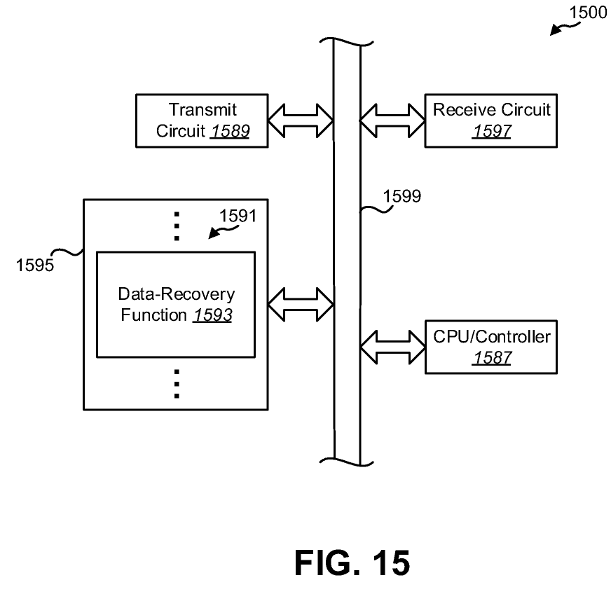

FIG. 15 is a block diagram illustrating part of a hardware implementation of an apparatus 1500 for executing the schemes or processes as described above. The apparatus 1500 may be a communication device, a user equipment, an access terminal, etc. The apparatus 1500 comprises circuitry as described below. In this specification and the appended claims, it should be clear that the term “circuitry” is construed as a structural term and not as a functional term. For example, circuitry can be an aggregate of circuit components, such as a multiplicity of integrated circuit components, in the form of processing and/or memory cells, units, blocks, and the like, such as is shown and described in FIG. 2.

In this configuration, the circuit apparatus is signified by the reference numeral 1500 and can be implemented in any of the communication entities described herein, such as the communication device.

The apparatus 1500 comprises a central data bus 1599 linking several circuits together. The circuits include a CPU (Central Processing Unit) or a controller 1587, a receive circuit 1597, a transmit circuit 1589 and a memory unit 1595.

If the apparatus 1500 is part of a wireless device, the receive circuit 1597 and the transmit circuit 1589 can be connected to an RF (Radio Frequency) circuit (which is not shown in the drawing). The receive circuit 1597 processes and buffers received signals before sending the signals out to the data bus 1599. On the other hand, the transmit circuit 1589 processes and buffers the data from the data bus 1599 before sending the data out of the device 1500. The CPU/controller 1587 performs the function of data management of the data bus 1599 and the function of general data processing, including executing the instructional contents of the memory unit 1595.

The memory unit 1595 includes a set of modules and/or instructions generally signified by the reference numeral 1591. In this configuration, the modules/instructions include, among other things, data-recovery function 1593 that carries out the schemes and processes as described above. The function 1593 includes computer instructions or code for executing the process steps as shown and described in FIGS. 5-7. Specific instructions particular to an entity can be selectively implemented in the function 1593. For instance, if the apparatus 1500 is part of a communication device or user equipment (UE), among other things, instructions particular to the communication device or UE as shown and described in FIG. 15 can be coded in the function 1593.

In this configuration, the memory unit 1595 is a RAM (Random Access Memory) circuit. The exemplary functions, such as the function 1593, include one or more software routines, modules, and/or data sets. The memory unit 1595 can be tied to another memory circuit (not shown), which either can be of the volatile or nonvolatile type. As an alternative, the memory unit 1595 can be made of other circuit types, such as an EEPROM (Electrically Erasable Programmable Read-Only Memory), an EPROM (Electrical Programmable Read-Only Memory), a ROM (Read-Only Memory), an ASIC (Application Specific Integrated Circuit), a magnetic disk, an optical disk, and others well known in the art.

In the above description, reference numbers have sometimes been used in connection with various terms. Where a term is used in connection with a reference number, this may be meant to refer to a specific element that is shown in one or more of the figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer or processor. Disk and disc, as used herein, includes compact disc (CD), laser disc, optical disc, digital versatile disc (DVD), floppy disk, and Blu-ray® disc, where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the systems, methods, and apparatus described herein without departing from the scope of the claims.

No claim element is to be construed under the provisions of 35 U.S.C. §112, sixth paragraph unless the element is expressly recited using the phrase “means for” or, in the case of a method claim, the phrase “step for.”

What is claimed is:

1. An apparatus operable in a communication system, comprising:
means for receiving a multimedia file segment that comprises damaged data; and
means for reconstructing the multimedia file segment using dummy data in place of the damaged data.

2. The apparatus of claim 1, further comprising:
means for determining whether critical parts of the multimedia file segment were received.

3. The apparatus of claim 2, further comprising means for playing the reconstructed multimedia file segment.

4. The apparatus of claim 3, wherein the means for playing the reconstructed multimedia file segment comprises means for playing the multimedia file segment until a location of the damaged data is reached.

5. The apparatus of claim 3, wherein the means for playing the reconstructed multimedia file segment comprises means for skipping locations of the damaged data.

6. The apparatus of claim 3, wherein the means for playing the reconstructed multimedia file segment comprises means for playing the dummy data in place of the damaged data.

7. The apparatus of claim 3, wherein the means for playing the reconstructed multimedia file segment comprises:
means for replacing the damaged data with data interpolated from undamaged parts of the multimedia file segment; and
means for playing the interpolated data in place of the damaged data.

8. The apparatus of claim 2, further comprising:
means for requesting retransmission of critical parts of the multimedia file segment that were not received.

9. The apparatus of claim 8, wherein the critical parts of the multimedia file segment comprise control boxes, an instantaneous decode refresh frame, data located earlier in the multimedia file segment, or an encoded base layer.

10. The apparatus of claim 2, wherein the multimedia file segment is transported by dynamic adaptive streaming using hypertext transfer protocol (DASH) over file delivery over unidirectional transport (FLUTE).

11. The apparatus of claim 10, wherein the critical parts of the multimedia file segment comprise a segment type box, a segment index box, or a first movie fragment box.

12. The apparatus of claim 10, wherein the critical parts of the multimedia file segment comprise a movie fragment random access box, and wherein the means for determining whether critical parts of the multimedia file segment were received comprises means for searching backward from an end of the multimedia file segment to locate the movie fragment random access box.

13. The apparatus of claim 10, wherein the critical parts of the multimedia file segment comprise a size and a type of a media data container box.

14. The apparatus of claim 1, further comprising means for requesting retransmission of the damaged data at a lower quality.

15. The apparatus of claim 1, wherein the multimedia file segment is received as part of an evolved multicast broadcast multimedia service (eMBMS) transmission.

16. An apparatus operable in a communication system, comprising:
circuitry configured to receive a multimedia file segment that comprises damaged data; and
circuitry configured to reconstruct the multimedia file segment using dummy data in place of the damaged data.

17. The apparatus of claim 16, further comprising:
circuitry configured to determine whether critical parts of the multimedia file segment were received.

18. The apparatus of claim 17, further comprising circuitry configured to play the reconstructed multimedia file segment.

19. The apparatus of claim 17, further comprising:
circuitry configured to request retransmission of critical parts of the multimedia file segment that were not received.

20. The apparatus of claim 16, further comprising circuitry configured to request retransmission of the damaged data at a lower quality.

21. A method operable by a communication device, comprising:
receiving a multimedia file segment that comprises damaged data; and
reconstructing the multimedia file segment using dummy data in place of the damaged data.

22. The method of claim 21, further comprising:
determining whether critical parts of the multimedia file segment were received.

23. The method of claim 22, further comprising playing the reconstructed multimedia file segment.

24. The method of claim 23, wherein playing the reconstructed multimedia file segment comprises playing the multimedia file segment until a location of the damaged data is reached.

25. The method of claim 23, wherein playing the reconstructed multimedia file segment comprises skipping locations of the damaged data.

26. The method of claim 23, wherein playing the reconstructed multimedia file segment comprises playing the dummy data in place of the damaged data.

27. The method of claim 23, wherein playing the reconstructed multimedia file segment comprises:
replacing the damaged data with data interpolated from undamaged parts of the multimedia file segment; and
playing the interpolated data in place of the damaged data.

28. The method of claim 22, further comprising:
requesting retransmission of critical parts of the multimedia file segment that were not received.

29. The method of claim 28, wherein the critical parts of the multimedia file segment comprise control boxes, an instantaneous decode refresh frame, data located earlier in the multimedia file segment, or an encoded base layer.

30. The method of claim 22, wherein the multimedia file segment is transported by dynamic adaptive streaming using hypertext transfer protocol (DASH) over file delivery over unidirectional transport (FLUTE).

31. The method of claim 30, wherein the critical parts of the multimedia file segment comprise a segment type box, a segment index box, or a first movie fragment box.

32. The method of claim 30, wherein the critical parts of the multimedia file segment comprise a movie fragment random access box, and wherein determining whether critical parts of the multimedia file segment were received comprises searching backward from an end of the multimedia file segment to locate the movie fragment random access box.

33. The method of claim 30, wherein the critical parts of the multimedia file segment comprise a size and a type of a media data container box.

34. The method of claim 21, further comprising requesting retransmission of the damaged data at a lower quality.

35. The method of claim 21, wherein the multimedia file segment is received as part of an evolved multicast broadcast multimedia service (eMBMS) transmission.

36. A computer-program product operable in a communication system, the computer-program product comprising a non-transitory computer-readable medium having instructions thereon, the instructions comprising:
code for causing an apparatus to receive a multimedia file segment that comprises damaged data; and
code for causing the apparatus to reconstruct the multimedia file segment using dummy data in place of the damaged data.

37. The computer-program product of claim 36, the instructions further comprising:
code for causing the apparatus to determine whether critical parts of the multimedia file segment were received.

38. The computer-program product of claim 37, the instructions further comprising code for causing the apparatus to receive the reconstructed multimedia file segment.

39. The computer-program product of claim 37, the instructions further comprising code for causing the apparatus to request retransmission of critical parts of the multimedia file segment that were not received.

40. The computer-program product of claim 36, the instructions further comprising code for causing the apparatus to request retransmission of the damaged data at a lower quality.
